(19) United States
(12) Patent Application Publication
(10) Pub. No.: US 2009/0206614 A1
(43) Pub. Date: Aug. 20, 2009

(54) Locker latch assembly

(76) Inventors: Matthew P. Washington, Geneva, IL (US); William G. Kozloski, Montgomery, IL (US); Charles E. Abens, Sandwich, IL (US)

Correspondence Address: SEYFARTH SHAW LLP, 131 S. DEARBORN ST., SUITE 2400, CHICAGO, IL, 60603-5803, US

(21) Appl. No.: 12/381,233

(22) Filed: Mar. 10, 2009

Related U.S. Application Data
(63) Continuation of application No. 10/925,692, filed on Aug. 24, 2004, now abandoned.
Application No. 10/925,692 is a continuation-in-part of application No. 10/887,571, filed on Jul. 9, 2004, now abandoned.

(51) Int. Cl. E05C 19/00

(52) U.S. Cl. 292/302

(57) ABSTRACT

A locker latch assembly has a bearing located on the part of the latch where the door-mounted portion of the latch contacts the frame-mounted portion of the latch which increases ease of use, effectiveness of latching, and reduces wear caused by friction between the parts.

### CROSS-REFERENCE TO RELATED APPLICATION

This is a continuation in-part application of U.S. application Ser. No. 10/887,571 filed on Jul. 9, 2004 and titled “Locker Latch Assembly.”

### BACKGROUND OF THE INVENTION

In many situations, lockers, and other lockable containers are very useful. Lockers are commonly used, for example, in schools and sports areas in order to provide temporary storage of personal belongings while a person is occupied in activities that do not require the belongings. For example, in a school, lockers permit students to store books for the appropriate class until needed, rather than carrying books for an entire day of classes all day. Another use of a locker permits changing clothes for working clothes to exercise clothes and back again.

Such lockers and other lockable containers utilize a wide range of latch mechanisms to make the container securely lockable. However, all such latch mechanisms have at least one frictional contact point between the components of the latch mechanism where the parts abut and must slide across each other. Such sliding inherently creates friction between the parts and causes wear on the parts. Not only does the operation of the latch become more difficult as this wear increases, ultimately, but such wear leads to malfunction of the latch and continual maintenance. That malfunction, in turn, adversely affects the operability of the latch mechanism and ultimately use of the locker.

The development of a latch assembly that minimizes and controls such friction-creating actions is very desirable and can greatly enhance the durability of a latch mechanism on a locker. With a latch assembly having reduced friction, wear is greatly reduced and the latch mechanism lasts longer, ultimately reducing maintenance issues and cost. Yet, prior art latch assemblies lack these desired features.

Of critical importance, with latch mechanisms for lockers, is the need for providing an improved latch assembly, which requires minimal modification of the components of the latch mechanism.

### SUMMARY OF THE INVENTION

Among the many objectives of this invention is the provision of a latch member for a latch mechanism that minimizes friction and wear between the interacting components.

A further objective of this invention is the provision of a latch member that reduces premature wear on the components.

Yet a further objective of this invention is the provision of a latch member, which greatly reduces structural modifications to an existing latch mechanism components locker.

A still further objective of this invention is the provision of a latch mechanism, which is easily installed into existing latch mechanisms. Another objective of this invention is the provision of a latch member, which minimizes a latch mechanism.

These and other objectives of the invention, which other objectives become clear by consideration of the specification, claims and drawings as a whole, are met by providing a locker latch assembly with a bearing, which minimizes friction and increases ease of use of the latch mechanism.

### BRIEF DESCRIPTION OF THE DRAWINGS

FIG. 1 is a perspective view of a prior art locker latch assembly typically disposed within a door of a locker.

FIG. 2 is an enlarged side view of the prior art slideable latch member 110 shown in FIG. 1.

FIG. 3 is a side cross-sectional view of the latch member of FIG. 2 taken along the approximate centerline of the latch member.

FIG. 4 is an enlarged side view of the latch member of FIG. 2 shown in cooperative retaining relationship with a well-known receiving bracket disposed on a locker in a well-known manner.

FIG. 5 is an enlarged side-view of an embodiment of the present application latch member.

FIG. 6 is a cross-sectional side view of the latch member of FIG. 5 taken along the approximate centerline of the latch member.

FIG. 7 is a view similar to FIG. 4 but shown with an embodiment of the latch member of the present application.

FIG. 8 is an enlarged perspective view of the latch member of FIG. 5 shown in abutting relation with the angled portion of the well-known receiving bracket.

FIG. 9 is an enlarged perspective view of the latch member of FIG. 6 shown in retaining relation with the receiving bracket.

FIG. 10 is a view similar to FIG. 8, but shown with an alternate embodiment of the latch member of the present application.

FIG. 11 is a side-view of the latch member of FIG. 10 shown in abutting relation with the angled portion of a well-known receiving bracket.

FIG. 12 is a side view of the latch member of FIG. 10 shown in retaining relation with the receiving bracket.

FIG. 13 is a perspective exploded view of the terminal end of an alternate embodiment of the latch member of the present application.

FIG. 14 is a cross-sectional side view of the latch member of FIG. 13 shown in retaining relation with the receiving bracket.

FIG. 15 is an exploded perspective view of a lock bar and lock bar slip of the present application.

FIG. 16 is a cross-sectional view of the assembled lock bar with lock bar clip of the present application taken along line in FIG. 15.

### DESCRIPTION OF THE PREFERRED EMBODIMENTS

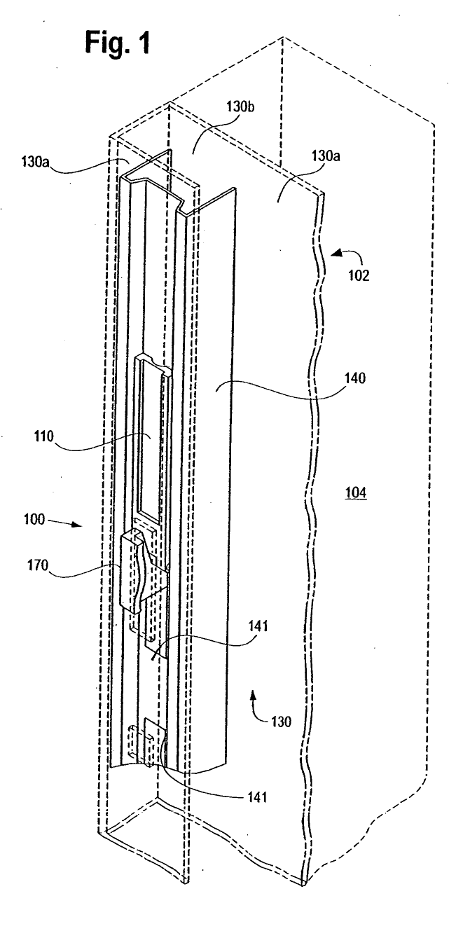

Referring to FIGS. 1-4, a latch assembly 100 for a locker 102 defined by a container 104 with a hingedly mounted container door 130 is disclosed. The container door 130 is typically constructed of sheet metal defining a plurality of walls 130a, that in turn cooperatively define a cavity 130b. A slideable lock bar 140 is disposed within the cavity 130b adjacent to the side opposing the hinge and is adapted to move between locked and unlocked positions relative to the container door 130 in a well-known manner. The lock bar 140 may be biased to the locked position in a well-known manner. The lock bar 140 includes a plurality of elongated apertures 141 disposed therein. At least one of the apertures 141 is adapted to slideably receive a latch member 110 constructed on a plastic material.

The latch member 110 is slideable between latched and unlatched positions relative to the lock bar 140. When the latch member 110 is disposed in the latched position, the latch member 110 is adapted to cooperate with a receiving bracket 122, which is coupled to the container 104 adjacent to the container opening and that communicates with the latch member 110 via apertures appropriately disposed on the container door 130 and lock bar 140, to retain the container door 130 in a closed position, relative to the container 104, in a well-known manner. More particularly, the terminal end of the latch body 180 is adapted to abut the receiving bracket 122 when the latch member 110 cooperates with the angled portion 122a of the receiving bracket 122 while the container door 130 is moved from the opened to closed positions, in a well-known manner. When the terminal end of the latch body 180 surpasses the edge 122b of the angle portion 122a, the latch member 110 is biased to the latched position wherein the latch body 180 is retainably received within the receiving bracket channel 122c.

The latch member 110 may be biased to the latched position in a well-known manner, such as with gravity or a spring coupled to the latch member 110. A handle 170 is slideably coupled to the container door 130 and is adapted to operably communicate with the latch member 110 to cause the latch member 110 to move to the unlatched position, when desired.

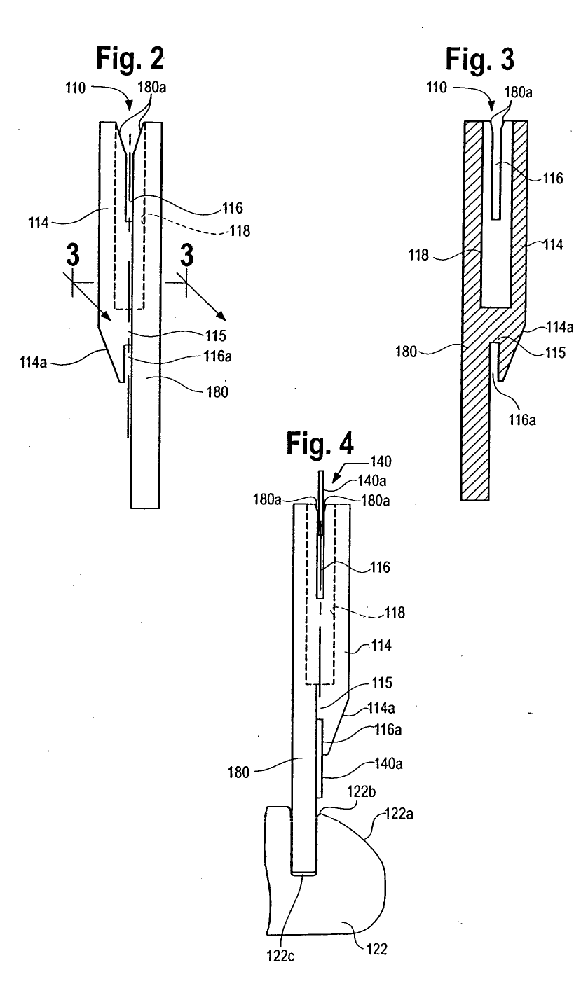

Referring particularly to FIGS. 2 and 3, latch member 110 includes a latch body 180 and a raised portion 114 disposed in spaced relation to the latch body 180 and integrally coupled thereto via a leg 115, thereby defining receiving slots 116, 116a therebetween that are adapted to slideably receive the sidewall 140a of the lock bar 140, in a well-known manner, when the latch assembly 100 is in an assembled condition as shown in FIG. 4. The respective termini of the latch body 180 and raised portion 114 include chamfered edges 180a in order to facilitate easy assembly of the latch assembly 100 by receiving the sidewall 140a of the lock bar 140 in a well-known manner. The opposing termini of the raised portion 114 includes a chamfered edge 114a disposed on the outward side of the raised portion 114, in relation to the latch body 180. Accordingly, when the latch member 110 is appropriately disposed within an elongated aperture of the lock bar 140, in a well-known manner, the latch member 110 can slideably move along the longitudinal axis of the lock bar 140 within the aperture, between the latched and unlatched positions, but cannot inadvertently be removed from the aperture.

Latch member 110 includes a substantially cylindrical bore 118 longitudinally disposed along the mounting slots 116, 116a and terminating within the leg 115. A biasing structure, such as a compression spring, may be disposed in the bore 118 to facilitate biasing of the latch member 110 to the latched position by abutting the edge of the sidewall 140a of the lock bar 140. Such a latch assembly 100 is well-known.

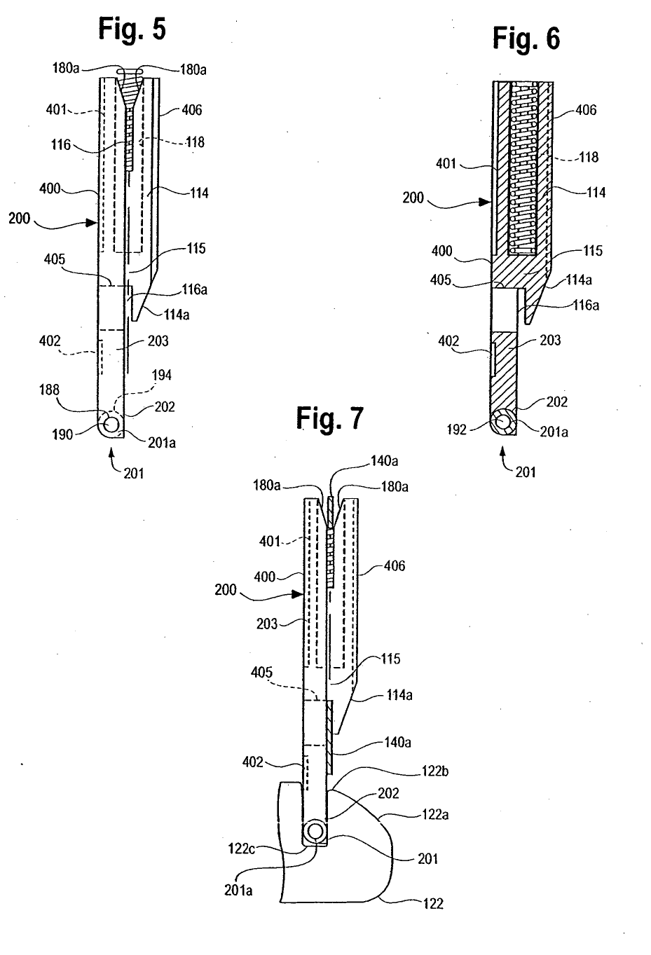

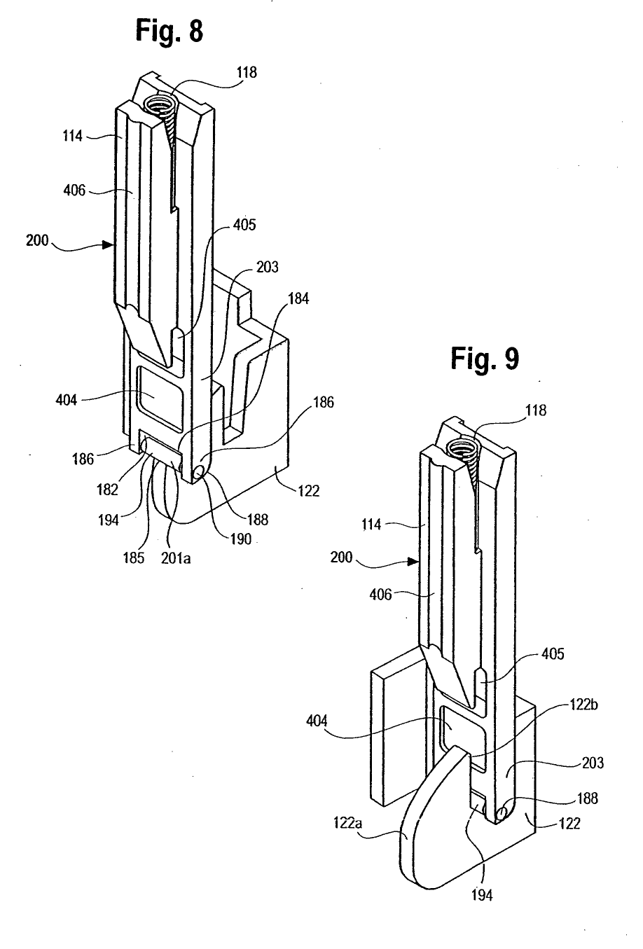

Now will be described the inventions of the present application. Referring to FIGS. 5-15, where like components of FIGS. 1-4 have been numbered, the latch member 200 includes a bearing portion 201 disposed thereon in substantial perpendicular relation to the same longitudinal axis of the latch member 200. In an embodiment, the bearing portion 201 is disposed at the terminal end 202 of the latch body 203 and is adapted to abut the angled portion 122a of the receiving bracket 122 when the latch member 200 cooperates with the receiving bracket 122 while the container door 130 is moved from the opened to closed position in a well-known manner. Accordingly, when the container door 130 is moved to the closed position relative to the locker 102, bearing portion 201 abuts the angled portion 122a of receiving bracket 122, thereby causing the slideable latch member 200 to move to the unlatched position relative to the lock bar 140. While the container door 130 continues to be moved to the closed position, the bearing portion 201 causes the latch member 200 to remain positioned in the unlatched position until bearing portion 201 moves beyond the edge 122b of the angled portion 122a, whereupon the latch member 201 is biased to the latched position and is retained by the receiving bracket channel 122c in a well-known manner. With latch member 200 having bearing 201, frictional engagement with receiving bracket 122, and more particularly the angled portion 122a, is more efficient and decreases excessive frictional wear on the terminal end 202 of the latch body 203 and the angled portion 122a.

Referring particularly to FIGS. 5-9 in an embodiment, the bearing 201 includes a roller bearing 201a comprising a substantially cylindrical member that is adapted to rotate relative to the later body 203. Within latch body 203, roller bearing 201a is supported in a U-shaped portion 182. Base 184 of U-shaped portion 182 is within latch body 203 in substantial transverse relation thereto, and oppositely disposed from open end 185. Extending from base 184 on either side of U-shaped portion 182 are arms 186. Each of arms 186, contains a pintle aperture 188. Roller bearing 201a has pintle pins 190 extending from a shaft 192. Bearing surface 194 of roller bearing 112a is disposed on shaft 192. Each pintle aperture 188 cooperatively receives a pintle pin 190 to retain bearing 112 in latch body 180.

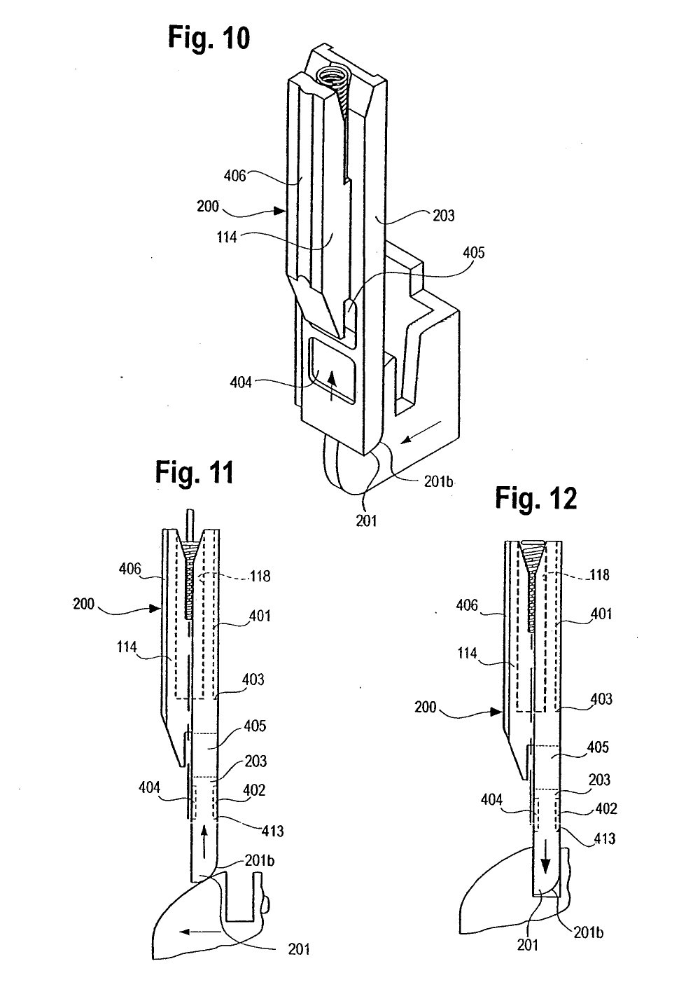

Referring particularly to FIGS. 10-12, another embodiment, the bearing 201 includes a radiused edge 201b of the latch body 203 that faces the receiving bracket 122 in order to facilitate slideable cooperation with the angled edge 122a. In an embodiment, the radius of the radiused edge 201b is approximately ⅛ inch. In another embodiment, the bearing 201 includes a chamfered edge of the latch body 203 facing the receiving bracket.

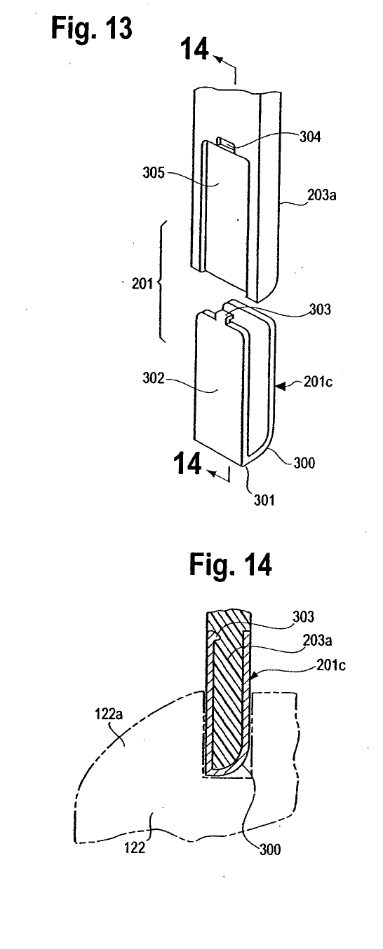

Referring particularly to FIGS. 13-14, in yet another embodiment, the bearing portion 201 includes a substantially U-shaped clip member 201c that is adapted to be inserted over the edge of the latch body 203a. In an embodiment, the clip member 201c is constructed of a metal material and is adapted to be frictionally coupled to a latch body 203a constructed of a plastic material. The corner 300 of the U-shaped clip member 201c that is adapted to abut the angled portion 122a of the receiving bracket 122 is substantially more arcuate compared to the opposing corner 301, thus creating a radiused edge. The terminal end of the back leg 302 may include an inwardly turned leg portion 303 that is adapted to retain the clip member 201c on the latch body 203a by cooperating with a detent structure 304 disposed on the latch body 203. In an embodiment, the latch body 203a includes a recess 305 adapted to receive the clip member 201c. Accordingly, in an assembled condition, the corner 300 facilitates a radiused edge of the latch body 180 that cooperates with the angled portion 122a.

Referring again to FIGS. 5-12, in an embodiment, the latch member 200 is constructed of a rigid material, such as metal. In an embodiment, the backside 400 of the latch body 203 includes recessed portions 401, 402 to conserve material usage during construction of the latch member 200. Recessed portions 401, 402 may be any shape or formed in any size. In an embodiment, recessed portion 401 is elongated and assumes a majority of the backside of the latch body 203. In an embodiment, recessed portion 402 is rectangular. In an embodiment, one or more corners 413 of each recessed portion may be accurate. In an embodiment, a third recessed portion 404 may be disposed on the frontside of the latch body 203 in a superimposed position relative to recess 402.

In another embodiment, an aperture 405 may be disposed on the latch body 203 in order to conserve material usage during construction of the latch member 200. The aperture 405 may be rectangular and may be disposed on the latch body adjacent to the lower terminal end of the raised portion 114.

In an embodiment, the outer side of the raised portion 114 includes reinforcing rib 406. Reinforcing rib 406 may extend substantially the length of the raised portion 114 and may be integrally formed therewith. In an embodiment, reinforcing rib 406 is substantially parallel to bore 118 and has an arcuate cross-sectional shape that proportionally conforms to the curvature of the sidewall of the bore 118.

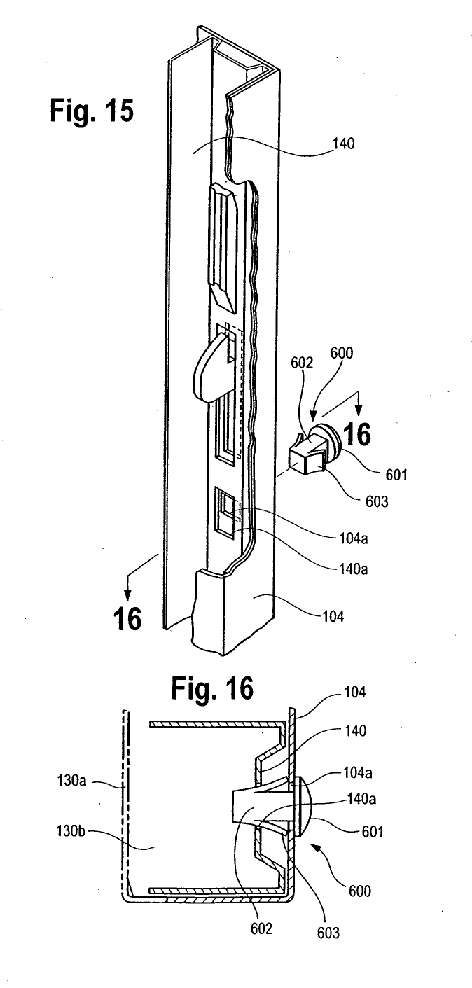

Referring now to FIGS. 15-16, an insert 600 for retaining the lock bar 140 in the door of a locker, wherein the door includes an aperture 104a disposed in substantial axial alignment with a substantially elongated aperture 140a disposed on the lock bar 140, is disclosed. The insert 600 includes a head 601, a body 602 extending substantially perpendicular from the head 601 and having a terminal end for insertion through the door aperture 104a and positionable in the lock bar aperture 140a, wherein the terminal end defines a guide along the lock bar aperture 140a for defined slideable movement of the lock bar 140 relative to the door 104. The insert 600 terminal end includes outwardly extending resilient wings 603 disposed and extending toward the head for retainable engagement with the backside of the sidewall of the door 130a adjacent to the door aperture 104a. The insert head 600 may be substantially circular in shape and is preferably larger than the door aperture 104a.

While particular embodiments of the present invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention. The matter set forth in the foregoing description and accompanying drawings is offered by way of illustration only and not as a limitation. The actual scope of the invention is intended to be defined in the following claims when viewed in their proper perspective based on the prior art.

1. A latch member for a locker latch assembly that slideably cooperates with a lock bar disposed within a locker door and is adapted to retain the door in a closed position by cooperating with a receiving bracket that includes an angled portion leading to a bracket recess that is adapted to retain the latch member against lateral movement when the latch member is moved to a latched position relative to the lock bar, the latch member comprising:
a latch body having a side profile;
a raised portion disposed in spaced relation to the latch body and integrally coupled thereto by a leg thereby defining receiving slots between the raised portion and the latch body that slideably receive a sidewall of the lock bar when the locker latch assembly is assembled;
a substantially cylindrical bore longitudinally disposed in one of the receiving slots and terminating within the leg;
a biasing structure disposed within the bore for biasing the latch member to the latched position; and
a bearing portion disposed on the latch body and positioned to be in engaging relationship with the angled portion of the receiving bracket when the latch member is moved to the latched position, said bearing portion including a rolling bearing located such that the rolling bearing does not extend substantially beyond the side profile, wherein at least a portion of the latch body engages the bracket recess when the latch member is in the latched position.

2.-5. (canceled)

6. The latch member as claimed in claim 1 wherein the latch member is constructed of a metal material.

7. (canceled)

8. The latch member as claimed in claim 1 wherein the latch body includes at least one recess on a backside thereof.

9. The latch member as claimed in claim 8 wherein the at least one recess is substantially rectangular.

10. The latch member as claimed in claim 8 wherein the latch body includes an aperture.

11. The latch member as claimed in claim 10 wherein the aperture is disposed on the latch body so that it communicates with one of the receiving slots.

12. The latch member as claimed in claim 1 wherein the raised portion includes a reinforcing rib disposed on a surface thereof and integrally formed therewith.

13. The latch member as claimed in claim 12 wherein the reinforcing rib is disposed substantially parallel to the bore.

14. The latch member as claimed in claim 12 wherein the reinforcing rib is part-cylindrical in shape.

15. (canceled)

16. (canceled)

17. The latch member as claimed in claim 8 wherein each recess is substantially rectangular.

18.-20. (canceled)

21. A latch member for a locker latch assembly that slideably cooperates with a lock bar disposed within a locker door and is adapted to retain the door in a closed position by cooperating with a receiving bracket that includes an angled portion leading to a bracket recess that is adapted to retain the latch member against lateral movement when the latch member is moved to a latched position relative to the lock bar, the latch member comprising:
a latch body having a side profile;
a raised portion disposed in spaced relation to the latch body and integrally coupled thereto by a leg thereby defining receiving slots between the raised portion and the latch body that slideably receive a sidewall of the lock bar when the locker latch assembly is assembled;
a substantially cylindrical bore longitudinally disposed in one of the receiving slots and terminating within the leg;
a biasing structure disposed within the bore for biasing the latch member to the latched position; and
a rolling bearing operably coupled to the latch body and positioned to be in engaging relationship with the angled portion of the receiving bracket when the latch member is moved to the latched position and such that the rolling bearing does not extend substantially beyond the side profile of the latch body.

22. The latch member as claimed in claim 21 wherein the latch member is constructed of a metal material.

23. The latch member as claimed in claim 21 wherein the latch body includes at least one recess on a backside thereof.

24. The latch member as claimed in claim 23 wherein the at least one recess is substantially rectangular.

25. The latch member as claimed in claim 23 wherein the latch body includes an aperture.

26. The latch member as claimed in claim 25 wherein the aperture is disposed on the latch body so that it communicates with one of the receiving slots.

27. The latch member as claimed in claim 21 wherein the raised portion includes a reinforcing rib disposed on a surface thereof and integrally formed therewith.

28. The latch member as claimed in claim 27 wherein the reinforcing rib is disposed substantially parallel to the bore.

29. The latch member as claimed in claim 27 wherein the reinforcing rib is part-cylindrical in shape.

30. The latch member as claimed in claim 23 wherein each recess is substantially rectangular.
